(19) United States
(12) Patent Application Publication
(10) Pub. No.: US 2007/0107999 A1
(43) Pub. Date: May 17, 2007

(54) Ventilated disk rotor and method of manufacturing the same

(76) Inventor: Masatoshi Kano, Toyota-shi (JP)

Correspondence Address: BUCHANAN, INGERSOLL & ROONEY PC, POST OFFICE BOX 1404, ALEXANDRIA, VA, 22313-1404, US

(21) Appl. No.: 11/589,936

(22) Filed: Oct. 31, 2006

(30) Foreign Application Priority Data
Nov. 15, 2005 (JP) 2005-330227
Dec. 16, 2005 (JP) 2005-363271

(51) Int. Cl. F16D 65/12

(52) U.S. Cl. 188/218 XL

(57) ABSTRACT

A ventilated disk rotor includes a pair of opposed annular sliding plates, a plurality of ribs and a plurality of ventilation holes. The ribs extend between the pair of the annular sliding plates. The plurality of ventilation holes are formed between the plurality of ribs. In addition a groove is positioned substantially at the center of the outer circumferential end or inner circumferential end of at least one of the plurality of ribs.

This application claims priority to Japanese patent applications serial number 2005-330227 and 2005-363271, the contents of which are incorporated herein by reference.

### BACKGROUND OF THE INVENTION

The present invention relates to a ventilated disk rotor, and more particularly to a ventilated disk rotor which reduces brake noise by improving vibration characteristics thereof.

Currently, various types of ventilated disk rotors are known. For example, one type of ventilated disk rotor has a pair of opposed annular sliding plates, and plural (N) ribs radially extending in the space between the pair of the annular sliding plates. The ribs are shifted from the reference position at n intervals such that the distances between the respective ribs are not uniform. In this structure, brake noise can be lowered.

Another type of ventilated disk rotor has controlled bending strength which is controlled by varying the plate thickness of annular sliding plates or other conditions. This adjustment prevents increase in the amplitude of coupled vibration generated by natural vibrations in the in-plane direction and in the vertical direction of the annular sliding plates, and therefore lowers brake noise.

However, according to the first prior art type of the ventilated disk rotor, there is a limitation to the width of ventilation holes provided between the ribs since the positions of the ribs are limited. In addition, other problems such as increase in the number of core types for the mold, have occurred in the ventilated disk rotor.

Moreover, the natural frequency of a disk rotor varies depending on the molding shapes and materials at the time of molding. However, the first prior art type of ventilated disk rotor does not make an adjustment for the natural frequency after molding, and therefore cannot control the variations in the natural frequency caused at the time of molding. Further, in the second type of ventilated disk rotor, the disk rotor measures the natural frequency after molding but does not perform any processing after the measurement. Thus, the disk rotor does not determine the plate thickness thereof or the like in the design process nor perform any processing after the measurement of the natural frequency.

Thus, there is a need in the art for a ventilated disk rotor capable of improved vibration characteristics and reduced brake noise, but by incorporating a structure in which the width of ventilation holes or other conditions is not affected, and an easy manufacturing method of the disk rotor.

### SUMMARY OF THE INVENTION

One aspect of the present invention can include a ventilated disk rotor includes a pair of opposed annular sliding plates, a plurality of ribs and ventilation holes. The ribs extend radially in the space between the pair of the annular sliding plates. The ventilation holes are formed between the ribs. In addition a groove is provided substantially at the center of the outer circumferential end or inner circumferential end of at least one of the plural ribs. The groove has a depth of 4 mm or larger in the radial direction.

Experimental data shows that the natural frequency of the disk rotor in the vertical direction is shifted to the low frequency side and brake noise is reduced when the groove is formed on the end of the rib. For example, according to the data, the peak value of the coupled vibration generated by the natural frequencies in the vertical direction can be in-plane direction can be decreased and thus brake noise is reduced since the natural frequency of the disk rotor in the vertical direction is shifted to the low frequency side in the direction away from the natural frequency in the in-plane direction.

The experimental data also shows that brake noise is lowered since the natural frequency of the disk rotor is shifted to a value not resonating with assembly components. The assembly components are vehicle components to be assembled with the disk rotor such as the pair of the pads to be pressed by the disk rotor, a piston which presses the pads onto the ventilated disk rotor, a brake assembly component having a caliper which contains the piston, and the entire vehicle body.

Since the groove is formed on the outer or inner circumferential end of the rib, other areas of the disk rotor are not easily affected by the groove. For example, since there is no specific limitation to the positions of the ribs, the width of the ventilation holes formed between the ribs is not limited. In addition, the groove does not vary the areas of the annular sliding plates.

Since the groove is located substantially at the center of the outer or inner circumferential end of the rib, the parts of the rib are left in the areas between the groove and the pair of the annular sliding plates. Thus, the left parts of the rib reinforce the areas between the outer or inner circumferential ends of the pair of the annular sliding plates.

In another aspect of the present invention, the groove is formed into a U-shaped.

In another aspect of the present invention, the groove is formed into a V-shaped. Preferably, an angle between the V-shaped groove and the annular sliding plates is 10 degrees or larger.

In another aspect of the present invention, the grooves are provided on all the plural ribs. Therefore, if the grooves are formed using a mold, a common core for the mold is used and thus production of the mold can be facilitated. If the grooves are formed by cutting the ribs, the disk rotor is axially rotated in the circumferential direction to form the grooves on all the plural ribs and thus the grooves can be easily provided on all the ribs.

The natural frequency of the disk rotor is shifted to the low frequency side by larger amount as the number of the grooves increases and the depth of the grooves enlarges. Thus, only a small depth and easy processing are obtained for the required grooves by forming the grooves on all the plural ribs.

In another aspect of the present invention, an attachment member to be attached to a wheel is provided on the inner circumference of one of the annular sliding plates. An adjustment member is provided on the inner circumference of the other annular sliding plate. And the adjustment member is cut to adjust the natural frequency of the disk rotor during the manufacturing process.

The experimental data illustrates that when the adjustment member is cut, the natural frequency of the disk rotor in the vertical direction within the low frequency range can be largely shifted to the lower frequency side and thus brake noise can be reduced.

Therefore, by forming the grooves on the ribs and cutting the adjustment member, the natural frequency (particularly vertical vibration) can be adjusted to a desired frequency and thus brake noise can be effectively prevented.

In another aspect of the present invention, a method of manufacturing the disk rotor includes a step of measuring the natural frequency of the disk rotor and a step of forming a groove by cutting at least one of the outer circumferential end or inner circumferential end of the plural ribs of the rotor to get a predetermined natural frequency of the disk rotor.

In this method, the natural frequency of the disk rotor can be securely and easily adjusted to the predetermined natural frequency. When the natural frequency is the predetermined frequency, brake noise can be securely reduced.

In the method of cutting the circumferential ends of the ribs, the grooves can be formed by applying the tool while axially rotating the disk rotor in the circumferential direction. Thus, the grooves can be easily provided on the circumferential ends of the ribs.

Since the grooves are formed on the outer or inner circumferential ends of the ribs, other areas of the disk rotor are not easily affected by the grooves. For example, the grooves do not give limitation to the width of the ventilation holes, nor changes the areas of the annular sliding plates.

In another aspect of the present invention, the grooves are formed substantially at the centers of the outer circumferential ends or inner circumferential ends of all the plural ribs of the disk rotor while rotating the disk rotor around the axis.

Thus, the grooves can be easily provided on all the ribs. The natural frequency of the disk rotor is shifted to the low frequency side by larger amount as the number of the grooves increases and the depth of the grooves enlarges. Thus, only a small depth and easy processing are obtained for the required grooves by forming the grooves on all the plural ribs.

In another aspect of the present invention, the disk rotor has an attachment member and an adjustment member. The attachment member is provided on the inner circumference of one of the annular sliding plates and is attached to a wheel. The adjustment member is provided on the inner circumference of the other annular sliding plate. And the natural frequency of the disk rotor is adjusted by cutting the adjustment member.

The experimental data shows that the natural frequency of the disk rotor in the vertical direction is shifted to the low frequency side when the grooves are formed on the circumferential ends of the ribs. Additionally, according to the data, the natural frequency of the disk rotor in the vertical direction within the low frequency range can be largely shifted to the lower frequency when the adjustment member is cut away. Accordingly, the natural frequency of the disk rotor can be adjusted to the desired frequency and thus brake noise can be effectively reduced or prevented.

In another aspect of the present invention, the natural frequencies of disk rotor in a vertical direction and in-plane direction are measured. And the groove is formed such that the natural frequency in the vertical direction can be shifted away from the natural frequency in the in-plane direction.

In another aspect of the present invention, the adjustment member is cut such that the natural frequency in the vertical direction can be shifted away from the natural frequency in the in-plane direction.

By adjusting the disk rotor such that the natural frequencies of the disk rotor in the vertical direction and in the in-plane direction can be shifted away from each other, the peak value of the coupled vibration generated by these natural frequencies can be decreased and thus brake noise can be reduced.

### BRIEF DESCRIPTION OF THE DRAWINGS

FIG. 1 is a perspective view of a disk rotor and a wheel hub;

FIG. 2 is a front cross-sectional view of a part of the disk rotor;

FIG. 3 is a cross-sectional view taken along line III-III in FIG. 2;

FIG. 4 is an expanded view of a part of FIG. 3;

FIG. 5 is an expanded front view of a part of FIG. 4 in the direction of arrow V in FIG. 4;

FIG. 6 is a perspective view of the disk rotor before adjusting frequency to show manufacturing the disk rotor;

FIG. 7 is a side schematic cross-sectional view of the disk rotor to show how to generate vertical vibration in the disk rotor;

FIG. 8 is a front schematic view of the disk rotor to show how to generate in-plane vibration in the disk rotor;

FIG. 9 is a frequency-amplitude diagram of in-plane and vertical vibration of the rotor before adjusting frequency;

FIG. 10 is a frequency-amplitude diagram of in-plane and vertical vibration of the rotor after forming grooves thereon;

FIG. 11 is an expanded cross-sectional view of another configuration similar to FIG. 4; and

FIG. 12 is an expanded cross-sectional view of the other configuration similar to FIG. 4.

### DETAILED DESCRIPTION OF THE INVENTION

Each of the additional features and teachings disclosed above and below may be utilized separately or in conjunction with other features and teachings to provide improved ventilated disk rotors. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful configurations of the present teachings.

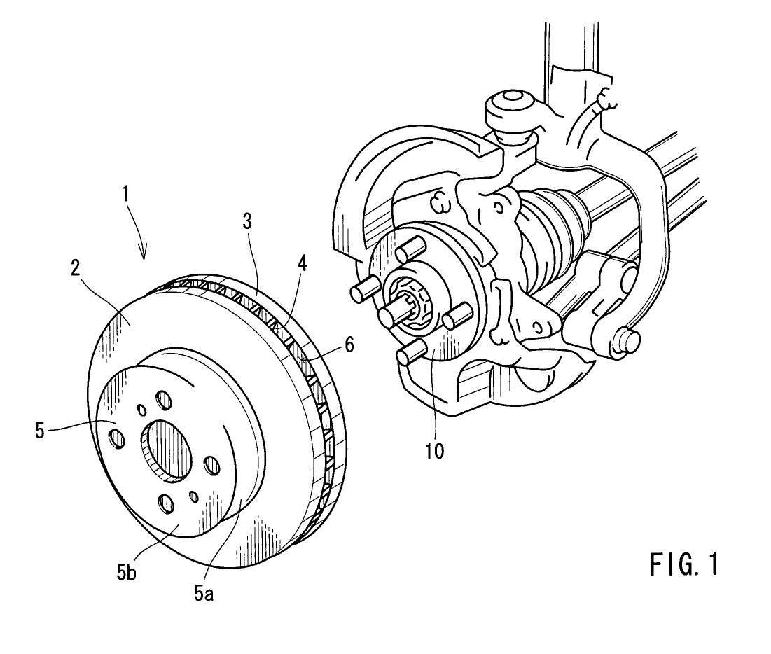

As shown in FIGS. 1 to 8, the configuration is designed for a ventilated disk rotor 1. This ventilated disk rotor 1 includes a pair of opposed annular sliding plates 2 and 3, a plurality of ribs 4 provided between the annular sliding plates 2 and 3, and an attachment member 5 to be attached to a wheel (wheel hub 10). The sliding plates 2 and 3, the ribs 4 and the attachment member 5 are formed into a one piece body.

As can be seen from FIGS. 1 through 3, the pair of the annular sliding plates 2 and 3 are doughnut-shaped disks.

The annular sliding plate 2 is disposed on the outer side of the vehicle, and an outer pad 11 slidingly contacts the outer surface of the sliding plate 2. The annular sliding plate 3 is disposed on the inner side of the vehicle, and an inner pad 12 slidingly contacts the inner surface of the sliding plate 3.

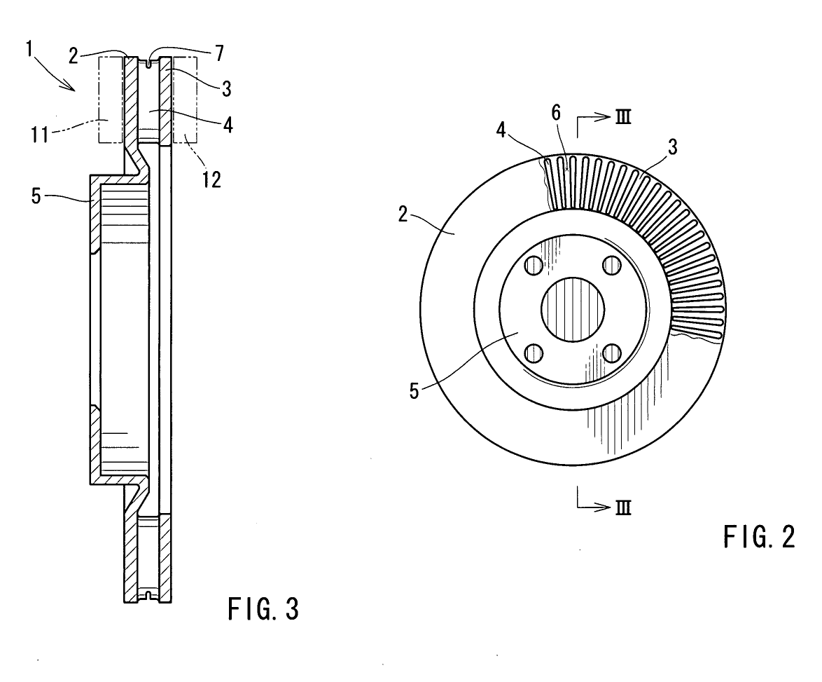

As shown in FIGS. 2 and 3, the plural ribs 4 are provided between the opposed annular sliding plates 2 and 3 at equal intervals in the circumferential direction. The ribs 4 extend in the radial direction from the inner circumferential ends to the outer circumferential ends of the annular sliding plates 2 and 3.

As illustrated in FIGS. 1 and 2, the plural ribs 4 can define a plurality of ventilation holes 6 in the space between the pair of annular sliding plates 2 and 3. Thus, when the disk rotor 1 is axially rotated in the circumferential direction, the plural ribs 4 push out air. Then, the air passes through the ventilation holes 6 and flow from the inner circumferences to the outer circumferences of the annular sliding plates 2 and 3.

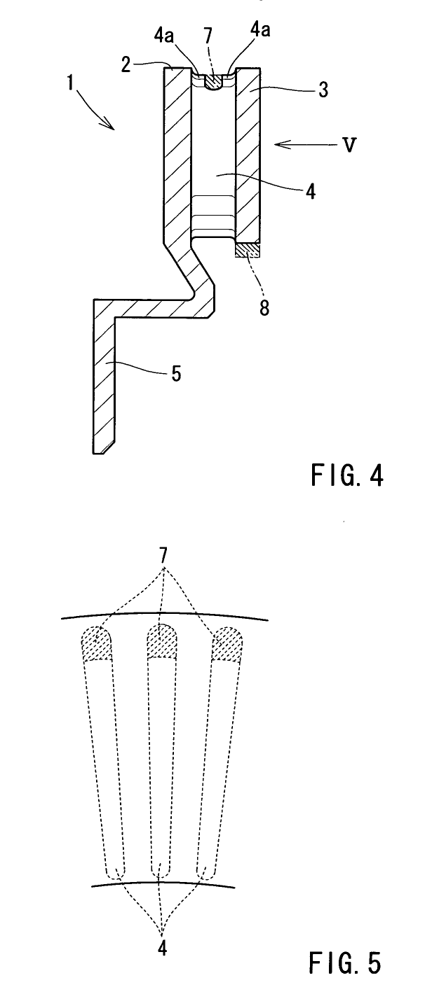

As illustrated in FIGS. 4 and 5, a groove 7 can be formed on the outer circumferential end of each rib 4. The groove 7 is U-shaped and has a depth of 4 mm or larger in the radial direction from the outer circumferential end of the rib 4. The depth is preferably in the range from 5 mm to 10 mm.

The groove 7 is positioned at the center of the outer circumferential end of the rib 4, and can have a width of one fourth or larger and two thirds or smaller of the width of the outer circumferential end of the rib 4. Thus, parts 4a of the rib 4 are left between the groove 7 and the annular sliding plates 2 and 3.

As shown in FIG. 1, the attachment member 5 to be attached to the wheel (wheel hub 10) can be equipped on the inner circumference of the outer-side annular sliding plate 2. The attachment member 5 has a cylindrical portion 5a and the disk portion 5b. The cylindrical portion 5a can be cylindrical and stands on the inner circumference of the annular sliding plate 2. The disk portion 5b can be disk-shaped and covers the distal end of the cylindrical portion 5a. The cylindrical portion 5a and the disk portion 5b can be formed integrally. The disk portion 5b has a plurality of attachment holes through which stud bolts of the wheel hub 10 can be inserted.

An adjustment member 8 can be provided on the inner circumference of the inner-side annular sliding plate 3. The adjustment member 8 can be formed along the entire or a part of the inner circumference of the annular sliding plate 3 at the time of molding. A part or the entire part of the adjustment member 8 can be cut away during the manufacturing process to control the natural frequency of the disk rotor 1.

According to the manufacturing method of the disk rotor 1, a rotor before frequency adjustment 20 (disk rotor) is initially formed using a mold. Then, the vertical vibration and in-plane vibration of the rotor before frequency adjustment 20 are measured.

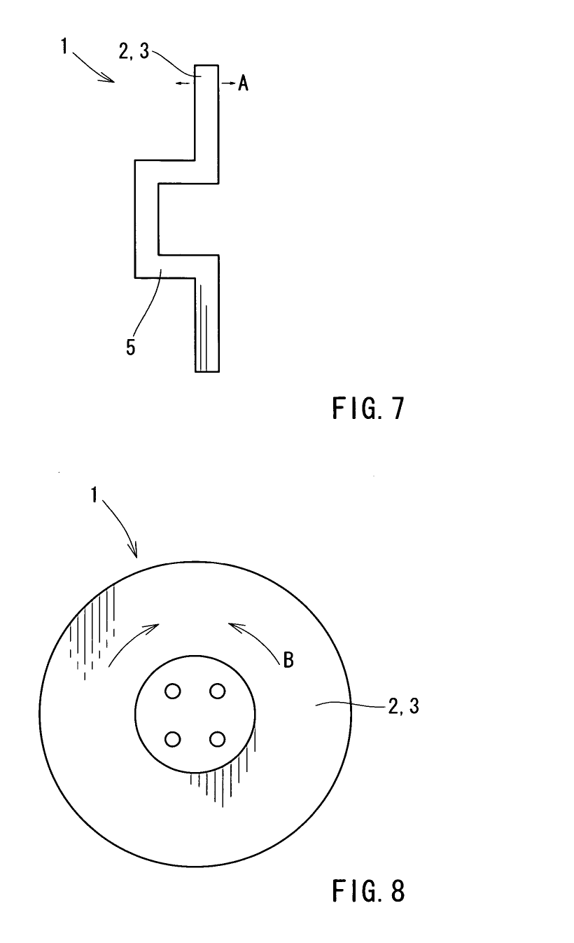

The vertical vibration is a vibration generated in the direction indicated by an arrow A (axial direction) of the annular sliding plate 2 or 3 in FIG. 7. The in-plane vibration is a vibration generated in the direction indicated by an arrow B (circumferential direction) of the annular sliding plate 2 or 3 in FIG. 8.

According to the method of measuring the vertical vibration, a stroke in the axial direction is given to the disk rotor 1 (the rotor before frequency adjustment 20) using an impulse hammer to vibrate the disk rotor 1. Then, the response wave generated by vibrating the disk rotor 1 is detected using a microphone, and the vertical vibration of the disk rotor 1 is analyzed by an analyzing device based on the peak positions of the sound pressure.

According to the method of measuring the in-plane vibration, a stroke in the radial direction is given to the outer circumferential side of the disk rotor 1 (the rotor before frequency adjustment 20) from the side using the impulse hammer, or a stroke is given to the attachment member 5 from the side or in the axial direction using the impulse hammer, to vibrate the disk rotor 1. Then, the response wave generated by vibrating the disk rotor 1 is detected using the microphone, and the in-plane vibration of the disk rotor 1 is analyzed by the analyzing device based on the peak positions of the sound pressure.

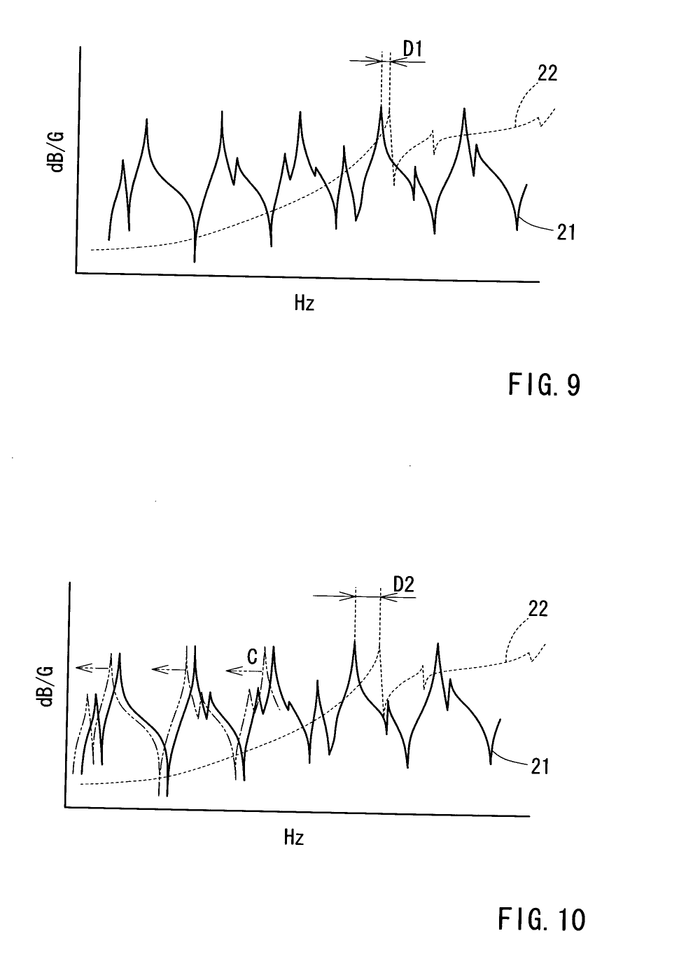

According to the result of the measurement shown in FIG. 9, a vertical vibration 21 has peaks of amplitude (inertance) in the frequency ranges substantially at equal intervals. An in-plane vibration 22 has peaks in a plurality of frequency ranges, and the peak value increases at higher frequencies.

As shown in FIG. 9, a distance D1 between one of the peaks of the vertical vibration 21 and one of the peaks of the in-plane vibration 22 is narrow. In this condition, the vertical vibration 21 and the in-plane vibration 22 are coupled and large amplitude is generated.

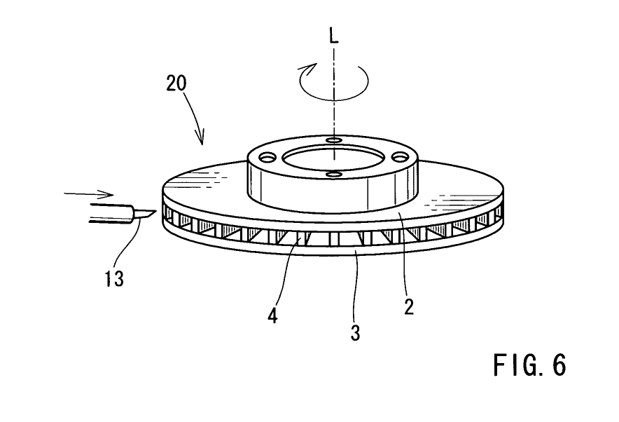

In order to prevent generation of large amplitude of the disk rotor 1, the rotor before frequency adjustment 20 is axially rotated in the circumferential direction (see FIG. 6) and the grooves 7 are formed on all the plural ribs 4 by applying a tool 13 to the outer circumferences of the ribs 4 (see FIG. 4). Then, the vertical vibration 21 and the in-plane vibration 22 of the rotor before frequency adjustment 20 are measured. According to the result of the measurement shown in FIG. 10, the entire vertical vibration 21 is shifted to the low frequency side, and the distance D1 shown in FIG. 9 is enlarged to a distance D2 shown in FIG. 10.

Subsequently, the rotor before frequency adjustment 20 is rotated around the axial center, and the adjustment member 8 is cut using a tool (see FIGS. 4 and 6). Then, the vertical vibration 21 and the in-plane vibration 22 of the rotor before frequency adjustment 20 are measured. According to the result of the measurement, only the vertical vibration 21 in the low frequency range is largely shifted in the direction indicated by an arrow C in FIG. 10 toward the low frequency side.

Thereafter, the rotor before frequency adjustment 20 is axially rotated in the circumferential direction and the above processing and measurement are repeated such that the natural frequency of the rotor before frequency adjustment 20 (disk rotor 1) becomes a desired frequency.

The disk rotor 1 has the above structure. In this structure, the U-shaped grooves 7 having a depth of 4 mm or larger in the radial direction are formed substantially at the center of the outer circumferential ends of the ribs 4 as illustrated in FIG. 4.

The experiments show that the natural frequency of the disk rotor 1 in the vertical direction is shifted to the low frequency side and brake noise is reduced when the U-shaped grooves 7 are formed on the outer circumferential ends of the ribs 4. For example, according to the experiments, the peak value of the coupled vibration generated by the natural frequencies in the vertical direction and in-plane direction is decreased and thus brake noise is reduced since the natural frequency of the disk rotor 1 in the vertical direction is shifted to the low frequency side in the direction away from the natural frequency in the in-plane direction.

In another example, according to the experiments, brake noise is lowered since the natural frequency of the disk rotor 1 is shifted to a value not resonating with assembly components. The assembly components are vehicle components to be assembled with the disk rotor 1 such as the pair of the pads 11 and 12 to be pressed by the disk rotor 1, a piston which presses the pads 11 and 12 onto the ventilated disk rotor, a brake assembly component having a caliper which contains the piston, and the entire vehicle body.

Since the grooves 7 are formed on the outer circumferential ends of the ribs 4, other areas of the disk rotor 1 are not easily affected by the grooves 7. For example, since there is no specific limitation to the positions of the ribs 4, the width of the ventilation holes 6 formed between the ribs 4 is not limited. In addition, the grooves 7 do not vary the areas of the annular sliding plates 2 and 3.

Since the grooves 7 are located substantially at the center of the outer circumferential ends of the ribs 4 as shown in FIG. 4, the parts 4a of the ribs 4 are left in the areas between the grooves 7 and the pair of the annular sliding plates 2 and 3. Thus, the left parts 4a of the ribs 4 reinforce the areas between the outer circumferential ends of the pair of the annular sliding plates 2 and 3.

The grooves 7 can be provided on all the plural ribs 4. As illustrated in FIG. 4, the adjustment member 8, which is cut away in the manufacturing process to control the natural frequency of the disk rotor 1, is provided along the inner circumference of the inner-side annular sliding plate 3.

According to the manufacturing method of the disk rotor 1, the natural frequency of the rotor before frequency adjustment 20 (disk rotor) formed using a mold is measured, and the groove 7 is formed by cutting the outer circumferential end of at least one of the plural ribs 4 of the rotor before frequency adjustment 20 such that the natural frequency becomes the predetermined natural frequency as illustrated in FIG. 6.

In this method, the natural frequency of the disk rotor 1 can be securely and easily adjusted to the predetermined natural frequency. When the natural frequency is the predetermined frequency, brake noise can be securely reduced.

In the method of cutting the outer circumferential ends of the ribs 4, the grooves 7 can be formed by applying the tool 13 from the outside while axially rotating the rotor before frequency adjustment 20 (disk rotor) in the circumferential direction. Thus, the grooves 7 can be easily provided on the outer circumferential ends of the ribs 4.

Since the grooves 7 are formed on the outer circumferential ends of the ribs 4, other areas of the disk rotor 1 are not easily affected by the grooves 7. For example, the grooves 7 do not give limitation to the width of the ventilation holes 6, nor changes the areas of the annular sliding plates 2 and 3.

According to the manufacturing method of the disk rotor 1, the rotor before frequency adjustment 20 (disk rotor) is rotated around the axis, and the grooves 7 are formed substantially at the center of the outer circumferential ends of all the plural ribs 4 of the rotor before frequency adjustment 20. Thus, the grooves 7 can be easily provided on all the ribs 4.

The natural frequency of the disk rotor 1 can be shifted to a low frequency by utilizing a configuration in which the amount of grooves 7 is increased or the depth of the grooves 7 is enlarged. Thus, is the configuration in which the number of grooves 7 is increased, each of the grooves only need a small depth and therefore, the processing in order to obtain the grooves 7 by forming the grooves 7 on all the plural ribs 4 is more easily performed.

According to the manufacturing method of the disk rotor 1, the natural frequency of the rotor before frequency adjustment 20 is adjusted by cutting the adjustment member 8.

The experimental data shows that the natural frequency of the disk rotor 1 in the vertical direction is shifted to the low frequency side when the grooves 7 are formed on the outer circumferential ends of the ribs 4. Additionally, according to the experiments, the natural frequency of the disk rotor 1 in the vertical direction within the low frequency range is largely shifted to the lower frequency when the adjustment member 8 is cut away. Accordingly, the natural frequency of the disk rotor 1 (especially the vertical vibration) can be adjusted to the desired frequency and thus brake noise can be effectively prevented.

According to the manufacturing method of the disk rotor 1, the natural frequencies of the rotor before frequency adjustment 20 (disk rotor) in the vertical direction and in the in-plane direction are measured, and before frequency adjustment 20, the rotor is cut such that the natural frequency in the vertical direction can be shifted away from the natural frequency in the in-plane direction.

By adjusting the rotor before frequency adjustment 20 such that the natural frequencies of the disk rotor 1 in the vertical direction and in the in-plane direction can be shifted away from each other, the peak value of the coupled vibration generated by these natural frequencies can be decreased and thus brake noise can be reduced.

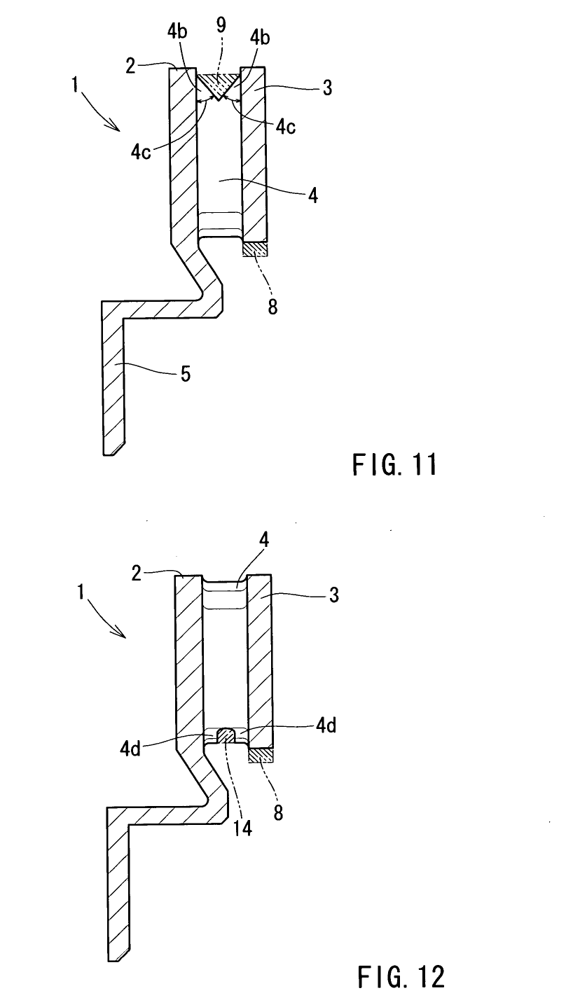

Another configuration according to the present invention will be described in reference to FIG. 11. This configuration is similar to the one shown in FIG. 4. However, FIG. 11 includes V-shaped grooves 9 in lieu of the U-shaped grooves 7 shown in FIG. 4. FIG. 11 will be described below, the description focusing on differences from FIG. 4.

The V-shaped grooves 9 are formed on the outer circumferential ends of all the ribs 4. Each of the grooves 9 has a depth of 4 mm or larger in the radial direction, preferably in the range from 5 mm to 10 mm. An angle 4c formed between the groove 9 and the annular sliding plates 2 and 3 is 10 degrees or larger, which inclination is larger than the draft angle of the mold (1-5 degrees). The angle 4c is preferably 30 degrees or larger, more preferably 45 degrees or larger, and 80 degrees or smaller. The angle 4c is measured between the central area of the depth of the groove 9 and the annular sliding plates 2 and 3.

The grooves 9 are formed not by cutting the ribs 4, but by using a mold. The adjustment member 8 provided on the inner circumference of the annular sliding plate 3 is cut if necessary.

The disk rotor 1 shown in FIG. 11 has the above structure. In this structure, the V-shaped grooves 9 each of which has a depth of 4 mm or larger in the radial direction from the outer circumferential end of the rib 4 and the angle 4c of 10 degrees or larger formed between the groove 9 and the annular sliding plates 2 and 3 are provided on the outer circumferential ends of the ribs 4 as illustrated in FIG. 11.

According to the experiments, it was found that in the disk rotor 1 having the V-shaped grooves 9 on the outer circumferential ends of the ribs 4, the natural frequency of the disk rotor 1 in the vertical direction can be shifted to the lower frequency side and thus brake noise can be reduced.

Since the grooves 9 are formed on the outer circumferential ends of the ribs 4, other areas of the disk rotor 1 are not easily affected by the grooves 9.

Additionally, since the angle 4c formed between the grooves 9 and the respective annular sliding plates is 10 degrees or larger, parts 4b of the ribs 4 are left in the areas between the grooves 9 and the pair of the annular sliding plates 2 and 3. Thus, the left parts 4b of the ribs 4 reinforce the areas between the outer circumferential ends of the pair of the annular sliding plates 2 and 3.

The grooves 9 are formed on all the plural ribs 4. In this structure, since a common core for the mold is used, production of the mold can be facilitated.

The other configuration according to the present invention will be described in reference to FIG. 12. This configuration is similar to the one shown in FIG. 4. However, FIG. 12 includes grooves 14 in lieu of the grooves 7 shown in FIG. 4. FIG. 12 will be described below, the description focusing on differences from FIG. 4.

The grooves 14 are formed on the inner circumferential ends of all the ribs 4. Each of the grooves 14 is U-shaped and has a depth of 4 mm or larger in the radial direction from the inner circumferential end of the rib 4. The depth of the grooves 14 is preferably in the range from 5 mm to 10 mm.

Each of the grooves 14 is positioned at the center of the inner circumferential end of the rib 4, and has a width which is one fourth or larger and two thirds or smaller of the width of the inner circumferential end. Thus, parts 4d of the ribs 4 are left between the groove 14 and the annular sliding plates 2 and 3.

Similarly to the case of the disk rotor 1 shown in FIGS. 4 and 6, the grooves 14 are formed by cutting the ribs 4 with a tool while axially rotating the rotor before frequency adjustment in the circumferential direction.

The disk rotor 1 shown in FIG. 12 has the above structure. In this structure, each of the U-shaped grooves 14 is located substantially at the center of the inner circumferential end of the rib 4 and has a depth of 4 mm or larger in the radial direction.

According to the experiments, it was found that in the disk rotor 1 having the U-shaped grooves 14 on the inner circumferential ends of the ribs 4, the natural frequency of the disk rotor in the vertical direction can be shifted to the lower frequency side and thus brake noise can be reduced.

Since the grooves 14 are formed on the inner circumferential ends of the ribs 4, other areas of the disk rotor 1 are not easily affected by the grooves 14.

Additionally, since the grooves 14 are formed substantially at the center of the inner circumferential ends of the ribs 4, the parts 4d of the ribs 4 are left in the areas between the grooves 14 and the pair of the annular sliding plates 2 and 3. Thus, the left parts 4d of the ribs 4 reinforce the areas between the inner circumferential ends of the pair of the annular sliding plates 2 and 3.

While the invention has been described with reference to specific configurations, it will be apparent to those skilled in the art that many alternatives, modifications and variations may be made. Accordingly, the present invention is intended to embrace all such alternatives, modifications and variations that may fall within the spirit and scope of the appended claims. For example, the present invention should not be limited to the representative configurations, but may be modified as described below.

The disk rotor 1 shown in FIG. 4 has grooves 7 that are formed by cutting the outer circumferential ends of the rotor before frequency adjustment. However, the grooves 7 may be formed using a mold.

While the disk rotors 1 shown in FIGS. 4, 11 and 12 have grooves on all the plural ribs, the groove may be provided on at least one of the outer or inner circumferences of the plural ribs.

While the disk rotor 1 shown in FIG. 11 has the V-shaped grooves 9 on the outer circumferential ends of the ribs 4 as illustrated in FIG. 10, the V-shaped grooves may be located on the inner circumferential ends of the ribs 4.

While the disk rotors 1 shown in FIGS. 4, 11 and 12 have the grooves on either the outer circumferential ends or inner circumferential ends of the ribs, the grooves may be provided on both the inner and outer circumferential ends of the ribs.

While the methods of manufacturing the disk rotor shown in FIGS. 4, 11 and 12 form the grooves on either the outer circumferential ends or inner circumferential ends of the ribs, the grooves may be formed on both the inner and outer circumferential ends of the ribs.

This invention claims:

1. A ventilated disk rotor comprising:
a pair of opposed annular sliding plates;
a plurality of ribs radially extending between the pair of the annular sliding plates;
a plurality of ventilation holes positioned between the ribs; and
a groove positioned substantially at the center of the outer circumferential end or inner circumferential end of at least one of the plural ribs, wherein the groove has a depth of approximately 4 mm or larger in the radial direction.

2. The ventilated disk rotor as in claim 1, wherein the groove is formed into a U-shaped.

3. The ventilated disk rotor as in claim 1, wherein the groove is formed into a V-shaped.

4. The ventilated disk rotor as in claim 3, wherein an angle between the V-shaped groove and the annular sliding plates is 10 degrees or larger.

5. The ventilated disk rotor as in claim 1, wherein the groove is positioned on all the plural ribs.

6. The ventilated disk rotor as in claim 1, further including an attachment member and a wheel, wherein the attachment member is attached to the wheel and is positioned on the inner circumference of one of the annular sliding plates further wherein an adjustment member is provided on the inner circumference of the other annular sliding plate, and the adjustment member is structured to adjust a natural frequency of the disk rotor.

7. A method of manufacturing a disk rotor comprising the steps of:
providing a pair of opposed annular sliding plates, a plurality of ribs radially extending in between the pair of the annular sliding plates, and ventilation holes formed between the ribs;
measuring a natural frequency of the disk rotor; and
forming a groove by cutting at least one of the outer circumferential end or inner circumferential end of the plural ribs of the rotor to obtain a predetermined natural frequency of the disk rotor.

8. The method of manufacturing a disk rotor as in claim 7, wherein the groove is formed substantially at the center of the outer circumferential end or inner circumferential end of each of the plurality of ribs while rotating the disk rotor around an axis.

9. The method of manufacturing a disk rotor as in claim 7, further including an attachment member and an adjustment member, the attachment member being provided on the inner circumference of one of the annular sliding plates and is attached to a wheel, and the adjustment member is provided on the inner circumference of the other annular sliding plate, wherein the natural frequency of the disk rotor is adjusted by cutting the adjustment member.

10. The method of manufacturing a disk rotor as in claim 7, wherein the natural frequency is measured in a vertical direction and in-plane direction and the groove is formed such that the natural frequency in the vertical direction can be shifted away from the natural frequency in the in-plane direction.

11. The method of manufacturing a disk rotor as in claim 9, wherein the natural frequency is measured in a vertical direction and in-plane direction and the adjustment member is cut such that the natural frequency in the vertical direction can be shifted away from the natural frequency in the in-plane direction.

12. A ventilated disk rotor comprising:
a pair of opposed sliding plates;
a plurality of ribs extending between a first and second annular sliding plate;
a plurality of ventilation holes positioned between the ribs; and
a groove positioned on at least one of an outer circumferential end and inner circumferential end of at least one of the plural ribs, wherein the groove has a depth of approximately 4 mm or larger.

13. The disk brake as in claim 12, further including an attachment member and a wheel.

14. The disk brake as in claim 13, wherein the attachment member is attached to the wheel and is positioned on the inner circumference of one of the annular sliding plates.

15. The disk brake as in claim 14, wherein an adjustment member is provided on the inner circumference of the other annular sliding plate, and the adjustment member is structured to adjust a natural frequency of the disk rotor.
